(19) United States
(12) Patent Application Publication
(10) Pub. No.: US 2007/0053748 A1
(43) Pub. Date: Mar. 8, 2007

(54) Activated carbon treatment of sediments contaminated with hydrophobic organic compounds

(76) Inventors: Richard G. Luthy, Stanford, CA (US); Jeanne Tomaszewski, Melnlo Park, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/512,740

(22) Filed: Aug. 29, 2006

Related U.S. Application Data
(63) Continuation-in-part of application No. 10/272,681, filed on Oct. 16, 2002, now Pat. No. 7,101,115.
(60) Provisional application No. 60/333,049, filed on Nov. 13, 2001.

(51) Int. Cl. B09C 1/08

(52) U.S. Cl. 405/128.5

(57) ABSTRACT

The present invention provides a method of remediating sediments through the use of coal-, plant-, or wood-derived carbon sorbents (i.e., black carbon). The strategy employs the addition to sediments of coal- and plant- or wood-derived carbon sorbents, so-called black carbon particles like activated carbon, char, charcoal, coal, and coke. These black carbon materials sorb hydrophobic organic compound contaminants strongly, thereby reducing environmental exposure and human health risk to such contaminants. By sorbing the contaminants from sediments, this approach reduces environmental exposure and allows sediments to be disposed of as non-hazardous material. This is a cost-effective and efficient remediation technology for contaminated sediment management that can significantly reduce expenditures and other problems with conventional approaches for dredging and remediating contaminated sediments.

### CROSS-REFERENCE TO RELATED APPLICATIONS

This application is a continuation-in-part of U.S. patent application Ser. No. 10/272,681, filed Oct. 16, 2002, which claims priority from U.S. Provisional Patent Application No. 60/333,049, filed Nov. 13, 2001, both of which are incorporated herein by reference.

### FIELD OF THE INVENTION

The present invention relates generally to remediation technologies for contaminated sediments. More particularly, the present invention relates to activated carbon treatment of sediments contaminated with hydrophobic organic compounds (HOCs).

### BACKGROUND

In 1997, the U.S. Environmental Protection Agency (EPA) estimated that 10 percent of the nation's lakes, rivers, and bays have sediment contaminated with toxic chemicals that can kill fish living in those waters or impair the health of people and wildlife who consume contaminated fish or water. The magnitude of the sediment contamination problem in the United States is evidenced by the more than 2,100 state advisories that have been issued against consuming fish. An important class of such contaminants are hydrophobic organic compounds (HOCs), which includes polycyclic aromatic hydrocarbons (PAHs), polybrominated biphenyls (PBBs), polychlorinated biphenyls (PCBs), pesticides (such as DDT), and some organometallic compounds (such as dimethyl mercury). HOCs are important contaminants of concern in sediments because of their association with fine-grained, organic-rich sediment material. HOCs persist in sediments for many years and exhibit the potential for bioaccumulation and toxicity. Thus, HOCs in sediments pose risks to human health and the environment.

The importance of the HOC contamination of sediments is exemplified by PCBs, which are long-lived in sediments and leach into overlying water, accumulate in benthic invertebrates, and transfer through the food chain to animals and humans. This has resulted in 697 fish consumption advisories for PCBs in the U.S. in 1998.

The most prevalent ex situ alternative for management of contaminated sediments is dredging. Current practices mandate disposal of dredged contaminated sediments in hazardous waste facilities, and often requires transport of contaminated sediments across states. For example, at Lauritzen Channel in Richmond, Calif., a Superfund site, the selected sediment remediation remedy specified dredging and dewatering of all soft bay mud material with off-site disposal at a hazardous waste site. Disposal of the sediments was planned in Colorado Springs, Colo., but public outcry moved the location to Mobile, Ariz. After dredging was completed in 1997, the sediments were hauled by train to Arizona, but growing public protests in Arizona eventually diverted some of the sediment to a site in Utah. Accordingly, there is a need in the art to provide methods of remediating dredged sediments that allow disposal of the dredged sediments as non-hazardous material.

### SUMMARY OF THE INVENTION

The present invention provides a method of remediating sediments through the use of coal-, plant-, or wood-derived carbon sorbents (i.e., black carbon). The strategy employs the addition to sediments of coal-, plant-, or wood-derived carbon sorbents, so-called black carbon particles like activated carbon, char, charcoal, coal, and coke. These black carbon materials sorb HOC contaminants strongly, thereby reducing environmental exposure and human health risk to such contaminants. By sorbing the contaminants in sediments, this approach reduces environmental exposure and allows sediments to be disposed of as non-hazardous material. This is a cost-effective and efficient remediation technology for contaminated sediment management that can significantly reduce expenditures and other problems with conventional approaches for remediating sediments. This technology will also increase control options and public acceptance.

According to a preferred embodiment of the present invention, the contaminated sediments are dredged sediments, and the carbon sorbent is activated carbon material. The weight of activated carbon materials mixed into the contaminated sediments is preferably between about 0.5% and about 10% the weight of the contaminated sediments. Contaminants amenable to remediation by this method include PAHs, PBBs, PCBs, and chlorinated organic materials, including pesticides such as DDT.

### BRIEF DESCRIPTION OF THE FIGURES

The present invention together with its objectives and advantages will be understood by reading the following description in conjunction with the drawings, in which:

FIG. 1 schematically shows reduction of PCB bioaccumulation in clam tissue following treatment of contaminated sediment with activated carbon according to the present invention.

FIG. 2 shows PCB bioavailability and aqueous equilibrium concentration reductions versus activated carbon dose used to treat sediments according to the present invention.

FIG. 3 shows reduction in DDT aqueous equilibrium concentration (A) and reduction in bioavailability as measured by a semi-permeable membrane device (SPMD) (B) as a function of type of activated carbon used to treat sediments according to the present invention.

FIG. 4 shows reduction in SPMD uptake compared to an untreated control after 1 and 6 months of mixing of DDT-contaminated sediments with activated carbon according to the present invention.

### DETAILED DESCRIPTION OF THE INVENTION

We recently discovered that PCBs and poly-aromatic hydrocarbons PAHs are very strongly bound to black carbon particles (e.g., charcoal, activated carbon, coal, coke, and char) in freshwater and marine sediments. Such PCBs and PAHs bound to black carbon particles do not appear to be easily leachable. Biological tests show that PAHs associated with black carbon in sediments are not available to microorganisms for biodegradation and also not available to earthworms for biological uptake. This means that black carbon particles in a wide variety of sediments can act as strong sorbents, which, naturally over time, tend to concentrate HOCs and make these compounds less available for organisms. Thus, the addition/deployment of fresh black carbon materials such as charcoal, coal, coke, char, and/or activated carbon to HOC-contaminated sediments can be used to effectively remediate sediments, preventing these sediments from leaching contaminants. This would facilitate the management and disposal of sediments containing HOC contaminants.

The application of fresh, highly adsorbing, coal-, plant-, and wood-derived carbon media to sediments in the field results in the transfer of hydrophobic contaminants from the available sediment components to the applied sorbent phase where the contaminants become much less bioavailable due to the strong binding to the sorbent material (see Examples). These results point to a new concept for sediment management based on addition of material like activated carbon to sediments. The efficiency of the technology depends on carbon sorbent type, the effects of different carbon dosages, contact times with sediment, and carbon particle sizes. The present invention is also applicable to other hydrophobic contaminants such as pesticides including DDT, and organometallics such as dimethyl mercury.

The addition of coal-, plant-, or wood-based carbon sorbent to contaminated sediment is a viable, cost effective remediation technology. It is anticipated that the amount of carbon sorbent added would be comparable to the organic carbon content of the sediment, about one to five percent by weight of sediment in the contaminated biologically active zone of the sediment. Depending upon the specific nature of the sediment being investigated, the added carbon sorbent can be in the range of about 0.5 to about 10% by weight of sediment. At present time, the material costs for representative treatments of 1 to 5% by weight of sediment are about $0.60 to $3/m³ using coke breeze at $35/ton, or about $10 to $50/m³ using regenerated activated carbon at $600/ton.

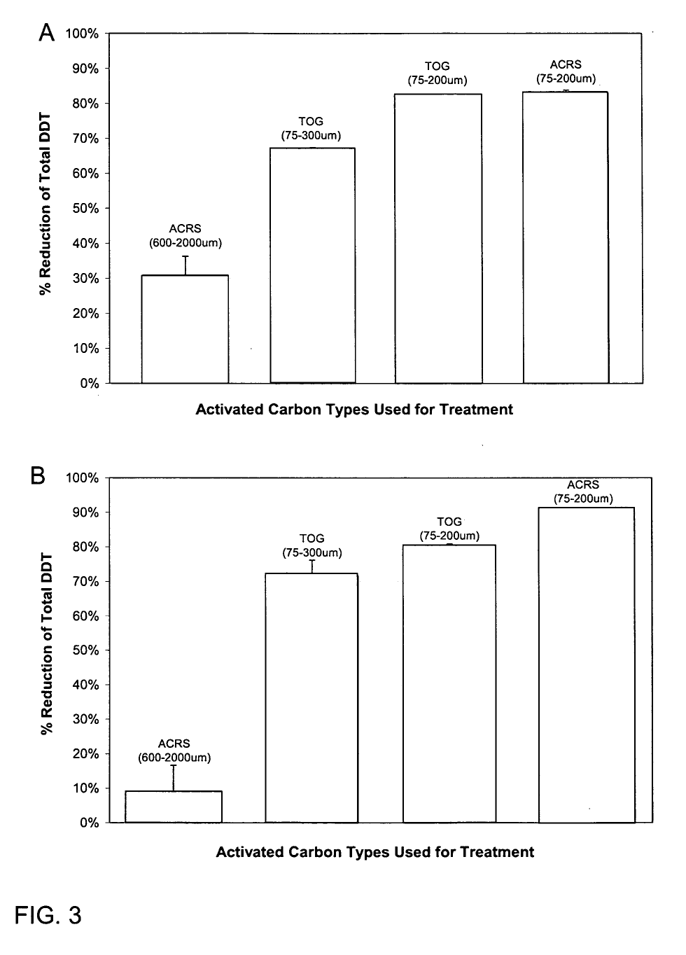

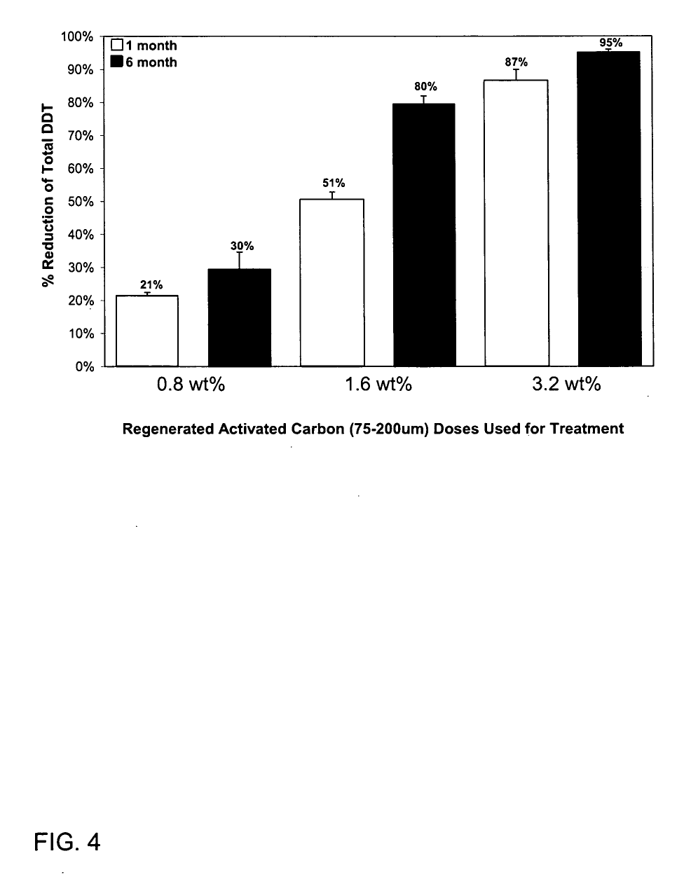

Various types of carbon sorbents may be used according to the present invention, including but not limited to charcoal, activated carbon, coal, coke, and char. Regenerated activated carbon may be used as a cost-effective alternative to virgin carbon as shown in FIGS. 3 and 4.

In a preferred embodiment, carbon sorbent is mixed into dredged sediments. Carbon sorbent may be mixed into dredged sediments in various ways. Mixing may occur during the normal operations of hydraulic dredging, in which sediment is pumped in a pipeline or hose into a holding container. In this case, carbon may be injected into the pipeline or hose at a predeterimined rate, thus achieving adequate mixing. For example, carbon could be injected into the dredged material discharge line in the case of hydraulic suction dredges. Alternatively, or in addition, carbon could be added to sediments at the point of discharge into a barge or holding vessel or disposal location.

If a clam shell or bucket is used for dredging, carbon may be mechanically mixed into the sediment when it is dumped into the barge, holding vessel, or disposal location. The mixing may occur during dumping or subsequent to dumping. Any type of mechanical mixing could be employed, including but not limited to bulk stirring. Alternatively, or in addition, mixing may occur by layering sediment and carbon sorbent. If contaminated sediment is placed in a confined disposal facility or other upland unit, then carbon could be injected into the wet sediment or plowed into the sediment using a tractor, mudcat or other piece of equipment designed not to get stuck in mud. Once the sediment and carbon are in contact long enough to achieve an acceptable level of available contaminant, as determined by procedures approved by the EPA and Army Corps of Engineers (ACE), the sediment can then be disposed in the ocean or a confined or unconfined non-hazardous waste facility, such as an upland unit.

It will be clear to one skilled in the art that the above embodiments may be altered in many ways without departing from the scope of the invention. For example, the physical properties of the carbon-based sorbent additive can be tailored or modified to aid future retrieval of the sorbent from the sediment if required or desired. Modification of the sorption properties of carbon-based sorbent can potentially enhance the sorption of heavy metal contaminants that may be present in the sediment. For example, sulfur may be added to activated carbon to sorb mercury. Additionally, reactive substances such as zero valent iron can be incorporated into the carbon-based additive for possible dechlorination of chlorinated compounds including PCBs or pesticides. Moreover, particle size and density of the carbon-based sorbent material can be modified to beneficially control resuspension. Accordingly, the scope of the invention should be determined by the following claims and their legal equivalents.

### EXAMPLES

### Example 1

Reduction of Availability of PCBs After Addition of Coke or Activated Carbon

Activated carbon has much higher surface area and sorption capacity compared to charcoal, coal, coke, and char, and is expected to work more efficiently. However, coke is inexpensive compared to activated carbon. Change in PCB availability was verified via physicochemical and biological tests after addition of coke and activated carbon to PCB contaminated sediment from Hunters Point, Calif. Aqueous desorption kinetic and equilibrium tests were performed using sediment that had been mixed with activated carbon or coke for 1 month or 6 months. Aqueous equilibrium tests showed reductions of 87% and 92% in aqueous PCB concentrations for sediment treated with activated carbon for 1- and 6-months contact periods, respectively. These results show that the addition of activated carbon reduces the availability of PCBs to the aqueous medium in contact with the sediment. Activated carbon is more effective than coke for treating PCB contaminated sediment. Treating sediment with coke reduced aqueous PAH concentrations up to 64% depending on coke dose, size, and contact time.

### Example 2

Decrease in PCB Accumulation in Clams as a Result of Mixing Sediment With Activated Carbon

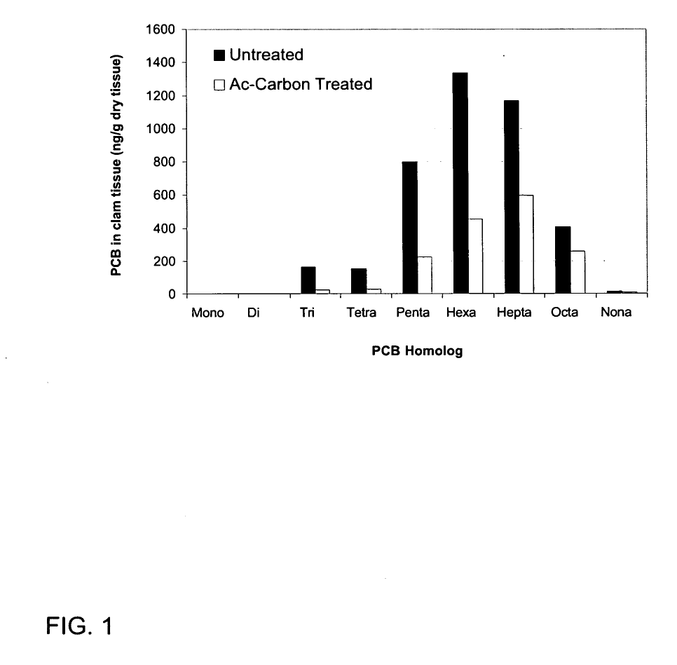

Our studies with PCB contaminated sediment and sediment-dwelling organisms showed that PCB accumulation significantly decreases as a result of activated carbon amendment. In an exemplary test, PCB bioaccumulation was determined by exposing a sediment dwelling clam (Macoma balthica) for a 28-day period to PCB contaminated sediment from Hunters Point, Calif. Prior to exposing the clams to the sediment, the sediment was mixed for one month in closed vessels with 3.4% activated carbon dry weight, which is double the total organic carbon content of the sediment. For a control sample, untreated sediment was mixed similarly. Clams were then added to the activated carbon treated sediment. FIG. 1 shows that the reduction in PCB uptake by homolog varied with PCB chlorination level and ranged from about 86% for the trichlorobiphenyls to about 18% for the nonachlorobiphenyls. The lower chlorinated PCB homologs are more strongly affected by the activated carbon treatment process. Higher chlorinated PCB homologs may be limited by the slow rates of mass transfer of PCBs from sediment into the sorbent carbon. Average reduction of total PCB uptake in clam tissue was about 84% for a sediment-sorbent contact period of one month. Longer contact periods are expected to result in greater efficiencies. Smaller activated carbon particle size results in greater efficiencies, as shown in other tests.

### Example 3

Biological Uptake Absorption Efficiency of HOC-Contaminated Carbonaceous Particles

The biological uptake absorption efficiency for 2,2′,5,5′-tetrachlorobiphenyl (a PCB compound) and benzo(a)pyrene (BaP, a PAH compound) from prepared particles by M. balthica was measured. Clams were fed ³H-labeled BaP and ¹⁴C-labeled PCB-spiked particles. These particles are representative of some of the black-carbonaceous particle types observed in Hunters Point and Milwaukee Harbor sediments. These spiked particles are coke, anthracite, wood, char, peat, and coal-based activated carbon. The pulse-chase feeding method was adopted to determine clam absorption efficiencies.

Feces and soft tissue from individual clams were analyzed for ³H-BaP and ¹⁴C-PCB. Clam absorption efficiency was computed as the physiological uptake of contaminant in soft tissues, and calculated for each clam as the ratio of ³H-BaP or ¹⁴C-PCB remaining in the clam to that remaining in tissue plus that depurated over 88 hrs as measured in the sum of the feces samples. Absorption efficiency was found lowest for activated carbon [<2%] and highest for wood [75%] and diatoms [85-90%]. It is clear that activated carbon dramatically reduces the biological absorption of the organic contaminant.

### Example 4

Reduction of PCB Bioavailability as a Function of Activated Carbon Dose

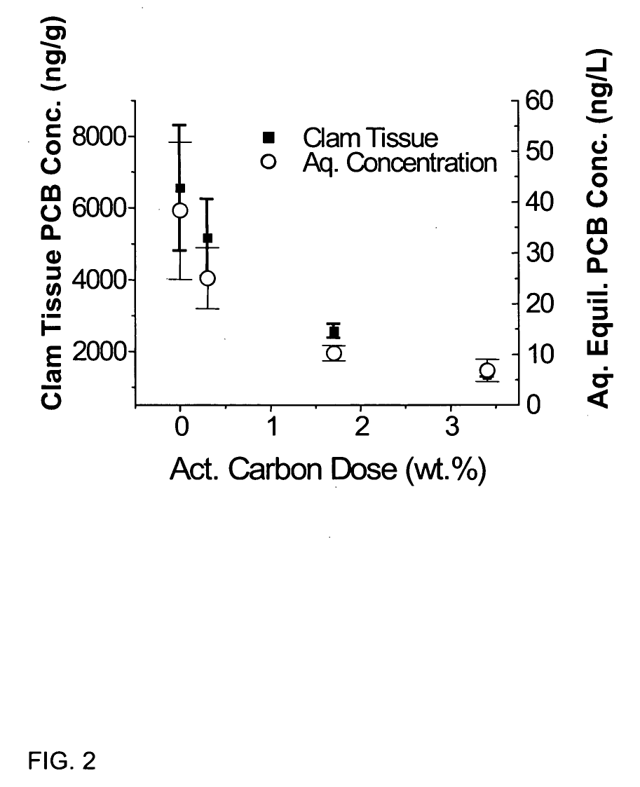

Varying amounts of activated carbon were mixed into Hunters Point sediments for 1 month. After this time, clam tissue PCB concentrations and aqueous equilibrium PCB concentrations were determined as described in Examples 2 and 1, respectively. Results are shown in FIG. 2. These data show a clear dose-response relationship in which PCBs are less available to both biota and the aqueous phase.

### Example 5

DDT Aqueous Equilibrium Concentration and Bioavailability as a Function of Type of Activated Carbon

TOG virgin activated carbon, size 75-300 μm and size 75-200 μm, and ACRS reactivated carbon, size 600-2000 μm and size 75-200 μm were mixed with DDT-contaminated sediments from Lauritzen Channel, Richmond, Calif., for one month at a 3.2 weight percent dose. After this time, aqueous equilibrium tests were performed as described above. Bioavailability was assessed using semi-permeable membrane devices (SPMDs), which are bio-mimetic passive uptake devices. This is a measure of “available” DDT. Results are shown in FIG. 3, with error bars indicating range of replicates. FIG. 3A shows reductions in aqueous equilibrium DDT concentrations and FIG. 3B shows reduction in DDT uptake by the SPMDs for treatment of DDT-contaminated sediment with 3.2 weight percent carbon and one month contact. The results suggest that regenerated carbons are as effective as virgin carbons. In addition, smaller sized carbon is more effective for remediating sediments contaminated with DDT in short-term tests.

### Example 6

Reduction of SPMD Uptake After 1 and 6 Months of Treatment With Activated Carbon

Regenerated activated carbon (75-200 μm) was mixed with DDT-contaminated sediments at varying concentrations and treatment times. Reduction of SPMD uptake was measured as described above. Results are shown in FIG. 4, with error bars indicating range of replicates. These data show the effectiveness of regenerated activated carbon increases with dose and contact time, achieving 95% reduction in available DDT levels with 6-month contact of 3.2 weight percent carbon. This work shows activated carbon amendment can be used to reduce the availability of DDT from Laurtizen Channel sediments to water, with a continuous decrease in SPMD uptake after contact for six months compared to one month. DDT is sequestered on the activated carbon particles.

What is claimed is:

1. A method for remediating hydrophobic organic compound contaminated sediments, comprising mixing activated carbon materials with said contaminated sediments,
wherein the weight of activated carbon materials mixed into said contaminated sediments is between about 0.5% and about 10% of the weight of said contaminated sediments.

2. The method as set forth in claim 1, wherein said hydrophobic organic compounds are selected from the group consisting of polycyclic aromatic hydrocarbons (PAHs), polybrominated biphenyls (PBBs), polychlorinated biphenyls (PCBs), and chlorinated organic compounds including pesticides.

3. The method as set forth in claim 1, wherein said contaminated sediments are dredged sediments.

4. The method as set forth in claim 3, wherein said mixing occurs while transporting said dredged sediments.

5. The method as set forth in claim 3, wherein said mixing occurs while said sediments are deposited into a barge, holding vessel, or disposal location.

6. The method as set forth in claim 3, wherein said mixing occurs after said sediments are deposited into a barge, holding vessel or disposal location.

7. The method as set forth in claim 1, wherein said activated carbon materials added to said contaminated sediments reduce the flux of said contaminants into water.

8. The method as set forth in claim 1, wherein said activated carbon materials added to said contaminated sediments reduce the biological uptake of said contaminants by benthic organisms.

9. The method as set forth in claim 1, further comprising modifying properties of said activated carbon materials to enhance sorption, wherein said properties include sorption properties and physical properties.

10. The method as set forth in claim 1, further comprising modifying particle size and density of said activated carbon materials.

11. The method as set forth in claim 1, wherein said activated carbon materials are virgin or regenerated.

12. The method as set forth in claim 1, further comprising depositing said remediated sediments in the ocean or in a non-hazardous waste facility.

13. The method as set forth in claim 1, wherein said mixing comprises layering said activated carbon materials and said contaminated sediments.

14. The method as set forth in claim 1, wherein said mixing comprises bulk stirring said activated carbon materials and said contaminated sediments.

15. The method as set forth in claim 1, further comprising incorporated zero valent iron into said activated carbon materials.
